(19) United States
(12) Patent Application Publication
(10) Pub. No.: US 2025/0066175 A1
(43) Pub. Date: Feb. 27, 2025

(54) LIFT DEVICE WITH MODULAR HOOD

(71) Applicant: Oshkosh Corporation, Oshkosh, WI (US)

(72) Inventors: Ignacy Puszkiewicz, Oshkosh, WI (US); Matthew Gilbride, Oshkosh, WI (US); Jesse Holmes, Oshkosh, WI (US); Jacob Josiah Richards, Oshkosh, WI (US); Wenton Miller, Oshkosh, WI (US); Scott Riley, Oshkosh, WI (US)

(73) Assignee: Oshkosh Corporation, Oshkosh, WI (US)

(21) Appl. No.: 18/814,068

(22) Filed: Aug. 23, 2024

Related U.S. Application Data
(60) Provisional application No. 63/534,462, filed on Aug. 24, 2023.

(51) Int. Cl. B66F 11/04

(52) U.S. Cl. CPC B66F 11/046

(57) ABSTRACT

A lift device may include a chassis. A lift device may include a turntable coupled to the chassis, the turntable comprising an internal frame and an external body. A lift device may include a lift assembly coupled to the turntable, the lift assembly configured to raise or lower a platform coupled to the lift assembly, wherein the external body comprises a plurality of body panels removably coupled to the internal frame to substantially enclose the internal frame and form an internal cavity, and wherein at least one of the plurality of body panels is a front panel comprising a counterweight. The front panel may be selected from a plurality of front panels based on one or more characteristics of the lift device.

### CROSS-REFERENCE TO RELATED PATENT APPLICATION

This application claims the benefit of and priority to U.S. Provisional Application No. 63/534,462, filed Aug. 24, 2023, the entire disclosure of which is incorporated by reference herein.

### BACKGROUND

The present disclosure relates to lift devices. More specifically, the present disclosure relates to modular components for lift device turntables.

### SUMMARY

At least one embodiment relates to a work machine including; a chassis; a turntable coupled to the chassis, the turntable including an internal frame and an external body; and a lift assembly coupled to the turntable, the lift assembly configured to raise or lower a platform coupled to the lift assembly, wherein the external body includes a plurality of body panels removably coupled to the internal frame to substantially enclose the internal frame and form an internal cavity, and wherein at least one of the plurality of body panels is a front panel including a counterweight.

In some aspects, the techniques described herein relate to a work machine, wherein in a retracted position of the lift assembly the platform is positioned proximate a rear of the work machine, and wherein the front panel is positioned at a front of the work machine opposite the rear.

In some aspects, the techniques described herein relate to a work machine, wherein the counterweight is a cast counterweight.

In some aspects, the techniques described herein relate to a work machine, further including a plurality of front panels of different weights, wherein the front panel is selected from the plurality of front panels based on a weight of the lift assembly.

In some aspects, the techniques described herein relate to a work machine, wherein the front panel is a first front panel including a first counterweight, the external body further including a second front panel including a second counterweight, the first front panel and the second front panel positioned on opposite sides of the lift assembly.

In some aspects, the techniques described herein relate to a work machine, wherein a first front panel weight and a second front panel weights are different.

Another embodiment relates to a work machine including; a chassis; a turntable coupled to the chassis, the turntable including an internal frame and an external body; and a lift assembly coupled to the turntable, the lift assembly configured to raise or lower a platform coupled to the lift assembly, wherein the external body includes a hood panel rotatably coupled to the internal frame via a hinge, the hinge including: a first linkage with a first length pivotably coupled to the hood panel and pivotably coupled to the internal frame such that the first linkage and the hood panel rotates around a first longitudinal axis; an arcuate second linkage with a second length slidably coupled to the hood panel and pivotably coupled to the internal frame such that the second linkage rotates around a second longitudinal axis, the second length shorter than the first length; a third linkage slidably coupled to the second linkage to traverse the second length; and an actuator pivotably coupled to the third linkage and pivotably coupled to the internal frame.

In some aspects, the techniques described herein relate to a work machine, wherein the first longitudinal axis is laterally offset from the second longitudinal axis.

In some aspects, the techniques described herein relate to a work machine, wherein the first longitudinal axis is longitudinally offset from the second longitudinal axis.

In some aspects, the techniques described herein relate to a work machine, wherein the first longitudinal axis is parallel to the second longitudinal axis.

In some aspects, the techniques described herein relate to a work machine, wherein the actuator is an electric actuator, a pneumatic cylinder, or a hydraulic actuator.

In some aspects, the techniques described herein relate to a work machine, wherein the third linkage is slidably coupled to the second linkage via a collar at a first end of the third linkage encircling the second linkage.

In some aspects, the techniques described herein relate to a work machine, wherein the second linkage is slidably coupled to the hood panel via a track coupled to the hood panel and a runner slidably coupled to the second linkage and slidably coupled to the track.

In some aspects, the techniques described herein relate to a work machine, wherein the first linkage is pivotably coupled to the hood panel a distance D from a top of the hood panel such that in an open position the top of the hood panel extends laterally inward past the first longitudinal axis.

In some aspects, the techniques described herein relate to a work machine, wherein the first linkage is pivotably coupled to the hood panel at a first position, and wherein the second linkage is slidably coupled to the hood panel between a top edge of the hood panel and the first position.

Another embodiment relates to a work machine, wherein the hinge is a first hinge, and wherein the hood panel is rotatably coupled to the internal frame via the first hinge and a second hinge, the second hinge including: a fourth linkage with a fourth length pivotably coupled to the hood panel and pivotably coupled to the internal frame such that the fourth linkage and the hood panel rotates around a fourth longitudinal axis; an arcuate fifth linkage with a fifth length slidably coupled to the hood panel and pivotably coupled to the internal frame such that the fifth linkage rotates around a fifth longitudinal axis, the fifth length shorter than the fourth length; a sixth linkage slidably coupled to the fifth linkage to traverse the fifth length; and a second actuator pivotably coupled to the sixth linkage and pivotably coupled to the internal frame.

In some aspects, the techniques described herein relate to a work machine, wherein the internal frame includes a longitudinal rail and a lateral rail coupled to the longitudinal rail, wherein the first linkage is rotatably coupled to a first post coupled to the lateral rail and extending orthogonal to the longitudinal rail and the lateral rail, the second linkage is rotatably coupled to an end of the lateral rail, and the actuator is rotatably coupled to a second post coupled to the lateral rail and extending away from the lateral rail orthogonal to the longitudinal rail and the lateral rail, the second post laterally inward relative to the first post.

In some aspects, the techniques described herein relate to a method of assembling a work machine including: providing a chassis; rotatably coupling a turntable to the chassis; pivotably coupling a lift assembly to the turntable, the lift assembly configured to raise or lower a platform coupled to the lift assembly; coupling a hood panel to an internal frame of the turntable, coupling a rear panel to the internal frame; and coupling a top panel to the internal frame, wherein the top panel is selected from a plurality of top panels of different widths based on one or more dimensions of the chassis, the turntable, or the lift assembly.

In some aspects, the techniques described herein relate to a method, further including selecting from steel or thermoplastics for the hood panel, the rear panel, or the top panel, based on a country of use for the work machine.

In some aspects, the techniques described herein relate to a method, wherein at least one of the hood panel, the rear panel or the top panel includes a cast counterweight.

### BRIEF DESCRIPTION OF THE DRAWINGS

FIG. 1 is a perspective view of a lift device, according to some embodiments

FIG. 2 is a perspective view of a base of the lift device of FIG. 1, according to some embodiments.

FIG. 3 is a perspective view of an axle assembly of the lift device of FIG. 1, according to some embodiments.

FIG. 4 is a perspective view of a platform assembly of the lift device of FIG. 1, according to some embodiments.

FIG. 5 is a right side of the lift device of FIG. 1 including a modular turntable hood, according to some embodiments.

FIG. 6 is a left side of the lift device of FIG. 5, according to some embodiments.

FIG. 7 is a front view of the lift device of FIG. 5, according to some embodiments.

FIG. 8 is a rear view of the lift device of FIG. 5, according to some embodiments.

FIG. 9 is a top view of the lift device of FIG. 5, according to some embodiments.

FIG. 10 is a perspective view of the modular turntable hood of FIG. 5, according to some embodiments.

FIG. 11 is an exploded view of the modular turntable hood of FIG. 10, according to some embodiments.

FIG. 12 is a top view of a lift device with a modular turntable hood, according to some embodiments.

FIG. 13 is a top view of another lift device with a modular turntable hood, according to some embodiments.

FIG. 14 is a top view of another lift device with a modular turntable hood, according to some embodiments.

FIG. 15 is a perspective view of the modular turntable hood of FIG. 10 in a first partially open position, according to some embodiments.

FIG. 16 is a perspective view of the modular turntable hood of FIG. 10 in a second partially open position, according to some embodiments.

FIG. 17 is a perspective view of the modular turntable hood of FIG. 10 in an open position, according to some embodiments.

FIG. 18 is a perspective view of a hinge of the modular turntable hood of FIG. 10, according to some embodiments.

FIG. 19 is a perspective view of a hinge of FIG. 18, according to some embodiments.

FIG. 20 is a perspective view of a hinge of FIG. 18, according to some embodiments.

FIG. 21 is a perspective view of a hinge of FIG. 18, according to some embodiments.

FIG. 22 is a perspective view of a lift device, according to some embodiments.

FIG. 23 is a perspective view of a modular hood of FIG. 22, according to some embodiments.

FIG. 24 is an exploded of the modular hood of FIG. 23, according to some embodiments.

### DETAILED DESCRIPTION

Before turning to the figures, which illustrate the exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overview

Referring generally to the FIGURES, a modular hood for a turntable of a lift device is shown, according to various embodiments. The modular hood is composed of a plurality of individual panels that couple to each other or to an internal frame of the turntable to substantially enclose and protect internal turntable components. The panels can be static panels or moveable to provide access to the internal turntable components. Individual panels may include counterweights, control inputs for operation of the lift device, and venturis to facilitate air intake and exhaust for the turntable. Each panel may be removably coupled to the turntable such that each individual panel may be removed as needed. Some panels may be common panels that are used on lift devices of different sizes. Other panels that interface with the common panels may be provided in multiple sizes such that they can enlarge (or reduce) the modular hood to fit the various lift devices, while still allowing for the common panels to be used. Individual panels of the modular hood can be made of different materials such as steel or thermoplastics, allowing a common base turntable to be customized for specific applications based on the panel selection.

### Lift Device

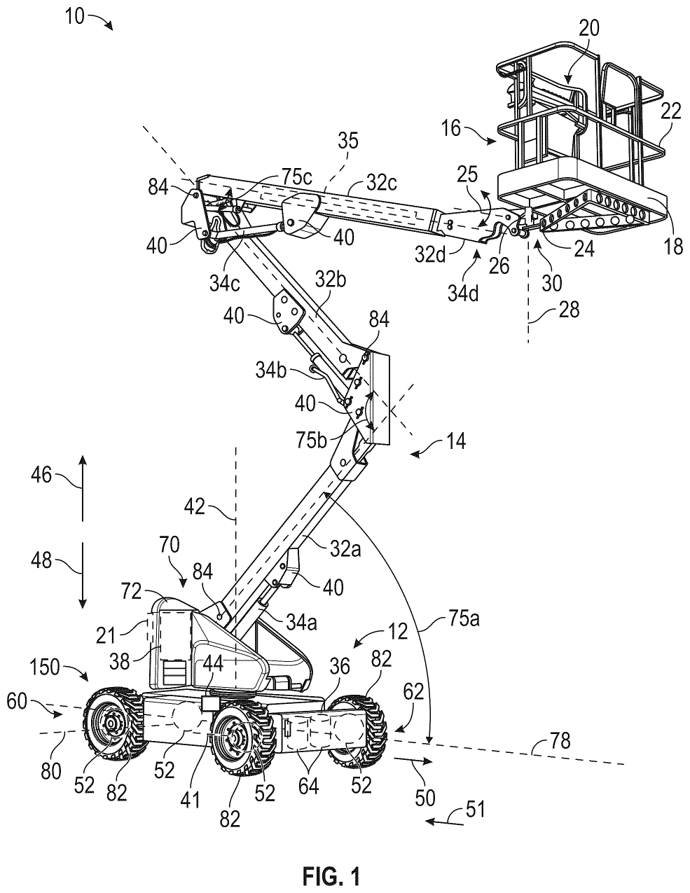

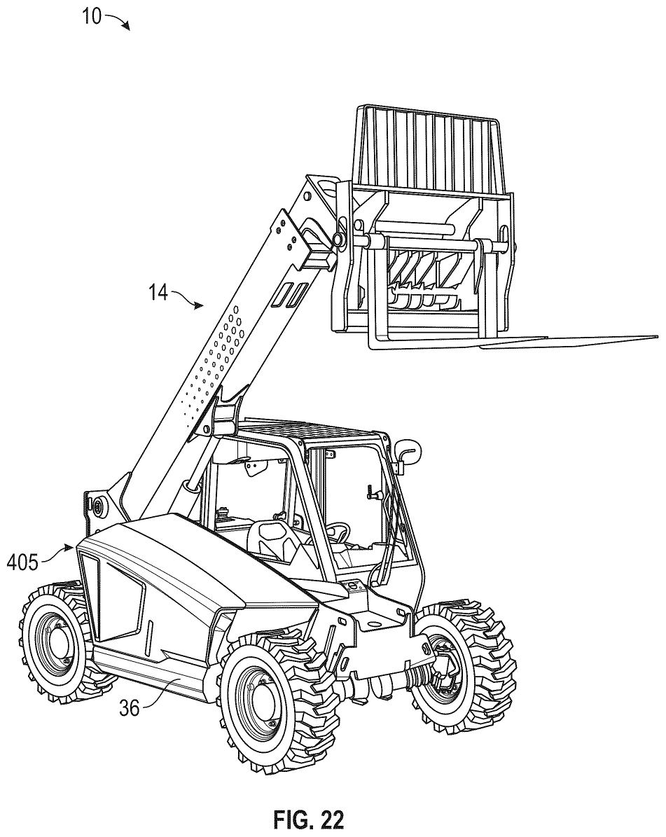

Referring to FIG. 1, a lifting apparatus, lift device, or mobile elevating work platform (MEWP) (e.g., a telehandler as shown in FIG. 22, an electric boom lift, a towable boom lift, a lift device, a fully electric boom lift, etc.), shown as lift device 10 includes a base assembly 12 (e.g., a base, a support assembly, a drivable support assembly, a support structure, a chassis, etc.), a platform assembly 16 (e.g., a platform, a terrace, etc.), and a lift assembly 14 (e.g., a boom, a boom lift assembly, a lifting apparatus, an articulated arm, a scissors lift, etc.). The lift device 10 includes a front end (e.g., a forward facing end, a front portion, a front, etc.), shown as front 62, and a rear end (e.g., a rearward facing end, a back portion, a back, a rear, etc.) shown as rear 60. The lift assembly 14 is configured to elevate the platform assembly 16 in an upwards direction 46 (e.g., an upward vertical direction) relative to the base assembly 12. The lift assembly 14 is also configured to translate the platform assembly 16 in a downwards direction 48 (e.g., a downward vertical direction). The lift assembly 14 is also configured to translate the platform assembly 16 in either a forwards direction 50 (e.g., a forward longitudinal direction) or a rearwards direction 51 (e.g., a rearward longitudinal direction). The lift assembly 14 generally facilitates performing a lifting function to raise and lower the platform assembly 16, as well as movement of the platform assembly 16 in various directions.

The base assembly 12 defines a longitudinal axis 78 and a lateral axis 80. The longitudinal axis 78 defines the forward direction 50 of lift device 10 and the rearward direction 51. The lift device 10 is configured to translate in the forward direction 50 and to translate backwards in the rearward direction 51. The base assembly 12 includes one or more wheels, tires, wheel assemblies, tractive elements, rotary elements, treads, etc., shown as tractive elements 82. The tractive elements 82 are configured to rotate to drive (e.g., propel, translate, steer, move, etc.) the lift device 10. The tractive elements 82 can each include an electric motor 52 (e.g., electric wheel motors) configured to drive the tractive elements 82 (e.g., to rotate tractive elements 82 to facilitation motion of the lift device 10). In other embodiments, the tractive elements 82 are configured to receive power (e.g., rotational mechanical energy) from electric motors 52 or through a drive train (e.g., a combination of any number and configuration of a shaft, an axle, a gear reduction, a gear train, a transmission, etc.). In some embodiments, one or more tractive elements 82 are driven by a prime mover 41 (e.g., electric motor, internal combustion engine, etc.) through a transmission. In some embodiments, a hydraulic system (e.g., one or more pumps, hydraulic motors, conduits, valves, etc.) transfer power (e.g., mechanical energy) from one or more electric motors 52 and/or the prime mover 41 to the tractive elements 82. The tractive elements 82 and electric motors 52 (or prime mover 41) can facilitate a driving and/or steering function of the lift device 10. In some embodiments, the electric motors 52 are optional, and the tractive elements 82 are powered or driven by an internal combustion engine.

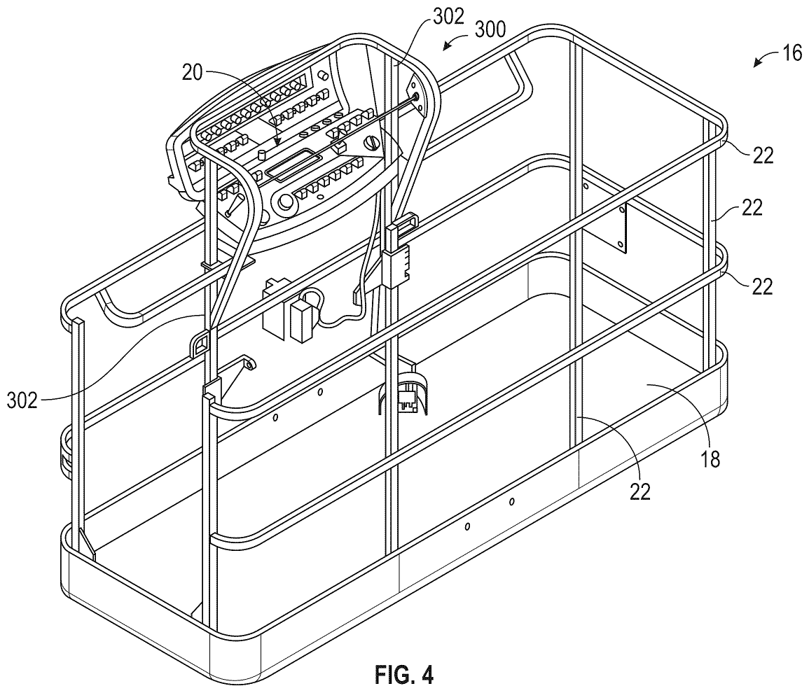

With additional reference to FIG. 4, the platform assembly 16 is shown in further detail. The platform assembly 16 is configured to provide a work area for an operator of the lift device 10 to stand/rest upon. The platform assembly 16 can be pivotably coupled to an upper end of the lift assembly 14. The lift device 10 is configured to facilitate the operator accessing various elevated areas (e.g., lights, platforms, the sides of buildings, building scaffolding, trees, power lines, etc.). The lift device 10 may use various electrically-powered motors and electrically-powered linear actuators or hydraulic cylinders to facilitate elevation and/or horizontal movement (e.g., lateral movement, longitudinal movement) of the platform assembly 16 (e.g., relative to the base assembly 12, or to a ground surface that the base assembly 12 rests upon). In some embodiments, the lift device 10 uses internal combustion engines, hydraulics, a hydraulic system, pneumatic cylinders, etc.

The platform assembly 16 includes a base member, a base portion, a platform, a standing surface, a shelf, a work platform, a floor, a deck, etc., shown as a deck 18. The deck 18 provides a space (e.g., a floor surface) for a worker to stand upon as the platform assembly 16 is raised and lowered.

The platform assembly 16 includes a railing assembly including various members, beams, bars, guard rails, rails, railings, etc., shown as rails 22. The rails 22 extend along substantially an entire perimeter of the deck 18. The rails 22 provide one or more members for the operator of the lift device 10 to grasp while using the lift device 10 (e.g., to grasp while operating the lift device 10 to elevate the platform assembly 16). The rails 22 can include members that are substantially horizontal to the deck 18. The rails 22 can also include vertical structural members that couple with the substantially horizontal members. The vertical structural members can extend upwards from the deck 18.

The platform assembly 16 can include a human machine interface (HMI) (e.g., a user interface, an operator interface, etc.), shown as the user interface 20. The user interface 20 is configured to receive user inputs from the operator at or upon the platform assembly 16 to facilitate operation of the lift device 10. The user interface 20 can include any number of buttons, levers, switches, keys, etc., or any other user input device configured to receive a user input to operate the lift device 10. The user interface 20 may also provide information to the user (e.g., through one or more displays, lights, speakers, haptic feedback devices, etc.). The user interface 20 can be supported by one or more of the rails 22.

Referring to FIG. 1, the platform assembly 16 includes a frame 24 (e.g., structural members, support beams, a body, a structure, etc.) that extends at least partially below the deck 18. The frame 24 can be integrally formed with the deck 18. The frame 24 is configured to provide structural support for the deck 18 of the platform assembly 16. The frame 24 can include any number of structural members (e.g., beams, bars, I-beams, etc.) to support the deck 18. The frame 24 couples the platform assembly 16 with the lift assembly 14. The frame 24 may be rotatably or pivotably coupled with the lift assembly 14 to facilitate rotation of the platform assembly 16 about an axis 28 (e.g., a vertical axis). The frame 24 can also rotatably/pivotably couple with the lift assembly 14 such that the frame 24 and the platform assembly 16 can pivot about an axis 25 (e.g., a horizontal axis).

The lift assembly 14 includes one or more beams, articulated arms, bars, booms, arms, support members, boom sections, cantilever beams, etc., shown as lift arms 32a, 32b, and 32c. The lift arms are hingedly or rotatably coupled with each other at their ends. The lift arms can be hingedly or rotatably coupled to facilitate articulation of the lift assembly 14 and raising/lowering and/or horizontal movement of the platform assembly 16. The lift device 10 includes a lower lift arm 32a, a central or medial lift arm 32b, and an upper lift arm 32c. The lower lift arm 32a is configured to hingedly or rotatably couple at one end with the base assembly 12 to facilitate lifting (e.g., elevation) of the platform assembly 16. The lower lift arm 32a is configured to hingedly or rotatably couple at an opposite end with the medial lift arm 32b. Likewise, the medial lift arm 32b is configured to hingedly or rotatably couple with the upper lift arm 32c. The upper lift arm 32c can be configured to hingedly interface/couple and/or telescope with an intermediate lift arm 32d. The upper lift arm 32c can be referred to as “the jib” of the lift device 10. The intermediate lift arm 32d may extend into an inner volume of the upper lift arm 32c and extend and/or retract. The lower lift arm 32a and the medial lift arm 32b may be referred to as “the boom” of the overall lift device 10 assembly. The intermediate lift arm 32d can be configured to couple (e.g., rotatably, hingedly, etc.), with the platform assembly 16 to facilitate levelling of the platform assembly 16.

The lift arms 32 are driven to hinge or rotate relative to each other by actuators 34a, 34b, 34c, and 34d (e.g., electric linear actuators, linear electric arm actuators, hydraulic cylinders, etc.). The actuators 34a, 34b, 34c, and 34d can be mounted between adjacent lift arms to drive adjacent lift arms to hinge or pivot (e.g., rotate some angular amount) relative to each other about pivot points 84. The actuators 34a, 34b, 34c, and 34d can be mounted between adjacent lift arms using any of a foot bracket, a flange bracket, a clevis bracket, a trunnion bracket, etc. The actuators 34a, 34b, 34c, and 34d may be configured to extend or retract (e.g., increase in overall length, or decrease in overall length) to facilitate pivoting adjacent lift arms to pivot/hinge relative to each other, thereby articulating the lift arms and raising or lowering the platform assembly 16.

The actuators 34a, 34b, 34c, and 34d can be configured to extend (e.g., increase in length) to increase a value of an angle formed between adjacent lift arms 32. The angle can be defined between centerlines of adjacent lift arms 32 (e.g., centerlines that extend substantially through a center of the lift arms 32). For example, the actuator 34a is configured to extend/retract to increase/decrease the angle 75a defined between a centerline of the lower lift arm 32a and the longitudinal axis 78 (angle 75a can also be defined between the centerline of the lower lift arm 32a and a plane defined by the longitudinal axis 78 and lateral axis 80) and facilitate lifting of the platform assembly 16 (e.g., moving the platform assembly 16 at least partially along the upward direction 46). Likewise, the actuator 34b can be configured to retract to decrease the angle 75a to facilitate lowering of the platform assembly 16 (e.g., moving the platform assembly 16 at least partially along the downward direction 48). Similarly, the actuator 34b is configured to extend to increase the angle 74b defined between centerlines of the lower lift arm 32a and the medial lift arm 32b and facilitate elevating of the platform assembly 16. Similarly, the actuator 34b is configured to retract to decrease the angle 74b to facilitate lowering of the platform assembly 16. The electric actuator 34c is similarly configured to extend/retract to increase/decrease the angle 74c, respectively, to raise/lower the platform assembly 16. The actuators 34 may be hydraulic actuators, electric actuators, pneumatic actuators, etc.

The actuators 34a, 34b, 34c, and 34d can be mounted (e.g., rotatably coupled, pivotably coupled, etc.) to adjacent lift arms at mounts 40 (e.g., mounting members, mounting portions, attachment members, attachment portions, etc.). The mounts 40 can be positioned at any position along a length of each lift arm. For example, the mounts 40 can be positioned at a midpoint of each lift arm, and a lower end of each lift arm.

The intermediate lift arm 32d and the frame 24 are configured to pivotably interface/couple at a platform rotator 30 (e.g., a rotary actuator, a rotational electric actuator, a gear box, etc.). The platform rotator 30 facilitates rotation of the platform assembly 16 about the axis 28 relative to the intermediate lift arm 32d. In some embodiments, the platform rotator 30 is positioned between the frame 24 and the upper lift arm 32c and facilitates pivoting of the platform assembly 16 relative to the upper lift arm 32c. The axis 28 extends through a central pivot point of the platform rotator 30. The intermediate lift arm 32d can also be configured to articulate or bend such that a distal portion of the intermediate lift arm 32d pivots/rotates about the axis 25. The intermediate lift arm 32d can be driven to rotate/pivot about axis 25 by extension and retraction of the actuator 34d.

The intermediate lift arm 32d is also configured to extend/retract (e.g., telescope) along the upper lift arm 32c. In some embodiments, the lift assembly 14 includes a linear actuator (e.g., a hydraulic cylinder, an electric linear actuator, etc.), shown as extension actuator 35, that controls extension and retraction of the intermediate lift arm 32d relative to the upper lift arm 32c. In other embodiments, one more of the other arms of the lift assembly 14 include multiple telescoping sections that are configured to extend/retract relative to one another.

The platform assembly 16 is configured to be driven to pivot about the axis 28 (e.g., rotate about axis 28 in either a clockwise or a counter-clockwise direction) by an electric or hydraulic motor 26 (e.g., a rotary electric actuator, a stepper motor, a platform rotator, a platform electric motor, an electric platform rotator motor, etc.). The motor 26 can be configured to drive the frame 24 to pivot about the axis 28 relative to the upper lift arm 32c (or relative to the intermediate lift arm 32d). The motor 26 can be configured to drive a gear train to pivot the platform assembly 16 about the axis 28.

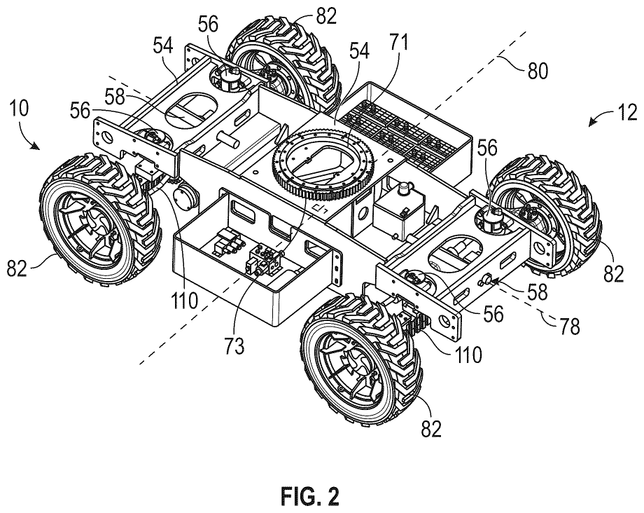

Referring to FIGS. 1 and 2, the lift assembly 14 is configured to pivotably or rotatably couple with the base assembly 12. The base assembly 12 includes a rotatable base member, a rotatable platform member, a fully electric turntable, etc., shown as a turntable 70. The lift assembly 14 is configured to rotatably/pivotably couple with the base assembly 12. The turntable 70 is rotatably coupled with a base, frame, structural support member, carriage, etc., of base assembly 12, shown as base 36. The turntable 70 is configured to rotate or pivot relative to the base 36. The turntable 70 can pivot/rotate about the central axis 42 relative to base 36, about a slew bearing 71 (e.g., the slew bearing 71 pivotably couples the turntable 70 to the base 36). The turntable 70 facilitates accessing various elevated and angularly offset locations at the platform assembly 16. The turntable 70 is configured to be driven to rotate or pivot relative to base 36 and about the slew bearing 71 by an electric motor, an electric turntable motor, an electric rotary actuator, a hydraulic motor, etc., shown as the turntable motor 44. The turntable motor 44 can be configured to drive a geared outer surface 73 of the slew bearing 71 that is rotatably coupled to the base 36 about the slew bearing 71 to rotate the turntable 70 relative to the base 36. The lower lift arm 32a is pivotably coupled with the turntable 70 (or with a turntable member 72 of the turntable 70) such that the lift assembly 14 and the platform assembly 16 rotate as the turntable 70 rotates about the central axis 42. In some embodiments, the turntable 70 is configured to rotate a complete 360 degrees about the central axis 42 relative to the base 36. In other embodiments, the turntable 70 is configured to rotate an angular amount less than 360 degrees about the central axis 42 relative to the base 36 (e.g., 270 degrees, 120 degrees, etc.).

The base assembly 12 includes one or more energy storage devices or power sources (e.g., capacitors, batteries, Lithium-Ion batteries, Nickel Cadmium batteries, fuel tanks, etc.), shown as batteries 64. The batteries 64 are configured to store energy in a form (e.g., in the form of chemical energy) that can be converted into electrical energy for the various electric motors and actuators of the lift device 10. The batteries 64 can be stored within the base 36. The lift device 10 includes a controller 38 that is configured to operate any of the motors, actuators, etc., of the lift device 10. The controller 38 can be configured to receive sensory input information from various sensors of the lift device 10, user inputs from the user interface 20 (or any other user input device such as a key-start or a push-button start), etc. The controller 38 can be configured to generate control signals for the various motors, actuators, etc., of the lift device 10 to operate any of the motors, actuators, electrically powered movers, etc., of the lift device 10. The batteries 64 are configured to power any of the motors, sensors, actuators, electric linear actuators, electrical devices, electrical movers, stepper motors, etc., of the lift device 10. The base assembly 12 can include a power circuit including any necessary transformers, resistors, transistors, thermistors, capacitors, etc., to provide appropriate power (e.g., electrical energy with appropriate current and/or appropriate voltage) to any of the motors, electric actuators, sensors, electrical devices, etc., of the lift device 10.

The batteries 64 are configured to deliver power to the motors 52 to drive the tractive elements 82. A rear set of tractive elements 82 can be configured to pivot to steer the lift device 10. In other embodiments, a front set of tractive elements 82 are configured to pivot to steer the lift device 10. In still other embodiments, both the front and the rear set of tractive elements 82 are configured to pivot (e.g., independently) to steer the lift device 10. In some examples, the base assembly 12 includes a steering system 150. The steering system 150 is configured to drive tractive elements 82 to pivot for a turn of the lift device 10. The steering system 150 can be configured to pivot the tractive elements 82 in pairs (e.g., to pivot a front pair of tractive elements 82), or can be configured to pivot tractive elements 82 independently (e.g., four-wheel steering for tight-turns).

It should be understood that while the lift device 10 as described herein is described with reference to batteries, electric motors, etc., the lift device 10 can be powered (e.g., for transportation and/or lifting the platform assembly 16) using one or more internal combustion engines, electric motors or actuators, hydraulic motors or actuators, pneumatic actuators, or any combination thereof.

In some embodiments, the base assembly 12 also includes a user interface 21 (e.g., a HMI, a user interface, a user input device, a display screen, etc.). In some embodiments, the user interface 21 is coupled to the base 36. In other embodiments, the user interface 21 is positioned on the turntable 70. The user interface 21 can be positioned on any side or surface of the base assembly 12 (e.g., on the front 62 of the base 36, on the rear 60 of the base 36, etc.).

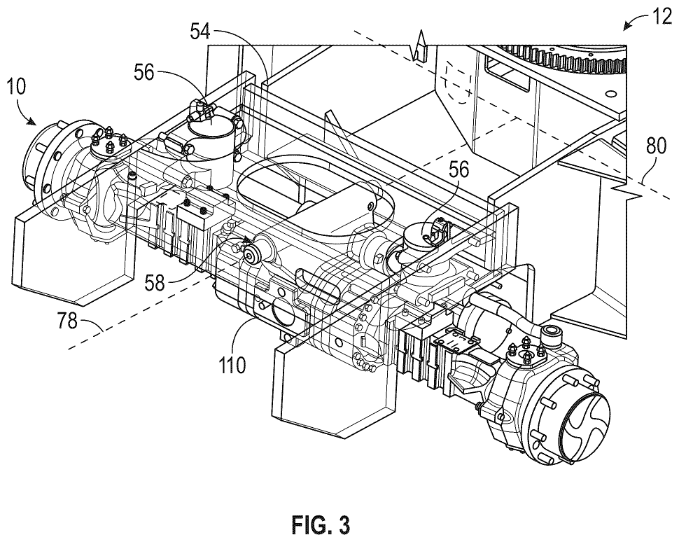

Referring now to FIGS. 2 and 3, the base assembly 12 includes a longitudinally extending frame member 54 (e.g., a rigid member, a structural support member, an axle, a base, a frame, a carriage, a chassis, etc.). The longitudinally extending frame member 54 provides structural support for the turntable 70 as well as the tractive elements 82. The longitudinally extending frame member 54 is pivotably coupled with lateral frame members 110 (e.g., axles, frame members, beams, bars, etc.) at opposite longitudinal ends of the longitudinally extending frame member 54. For example, the lateral frame members 110 may be pivotably coupled with the longitudinally extending frame member 54 at a front end and a rear end of the longitudinally extending frame member 54. The lateral frame members 110 can each be configured to pivot about a pivot joint 58 (e.g., about a longitudinal axis). The pivot joint 58 can include a pin and a receiving portion (e.g., a bore, an aperture, etc.). The pin of the pivot joint 58 is coupled to one of the lateral frame members 110 (e.g., a front lateral frame member 110 or a rear lateral frame member 110) or the longitudinally extending frame member 54 and the receiving portion is coupled to the other of the longitudinally extending frame member 54 and the lateral frame member 110. For example, the pin may be coupled with longitudinally extending frame member 54 and the receiving portion can be coupled with one of the lateral frame members 110 (e.g., integrally formed with the front lateral frame member 110).

In some embodiments, the longitudinally extending frame member 54 and the lateral frame members 110 are integrally formed or coupled (e.g., fastened, welded, riveted, etc.) to define the base 36. In still other embodiments, the base 36 is integrally formed with the longitudinally extending frame member 54 and/or the lateral frame members 110. In still other embodiments, the base 36 is coupled with the longitudinally extending frame member 54 and/or the lateral frame members 110.

The base assembly 12 includes one or more axle actuators 56 (e.g., electric linear actuators, electric axle actuators, electric levelling actuators, hydraulic cylinders, etc.). The axle actuators 56 can be linear actuators configured to receive power from the batteries 64, for example. The axle actuators 56 can be configured to extend or retract to contact a top surface of a corresponding one of the lateral frame members 110. When the axle actuators 56 extend, an end of a rod of the levelling actuators can contact the surface of lateral frame member 110 and prevent relative rotation between lateral frame member 110 and longitudinally extending frame member 54. In this way, the relative rotation/pivoting between the lateral frame member 110 and the longitudinally extending frame member 54 can be locked (e.g., to prevent rolling of the longitudinally extending frame member 54 relative to the lateral frame members 110 during operation of the lift assembly 14). The axle actuators 56 can receive power from the batteries 64, which can allow the axle actuators 56 to extend or retract. The axle actuators 56 receive control signals from controller 38.

### Modular Hood System

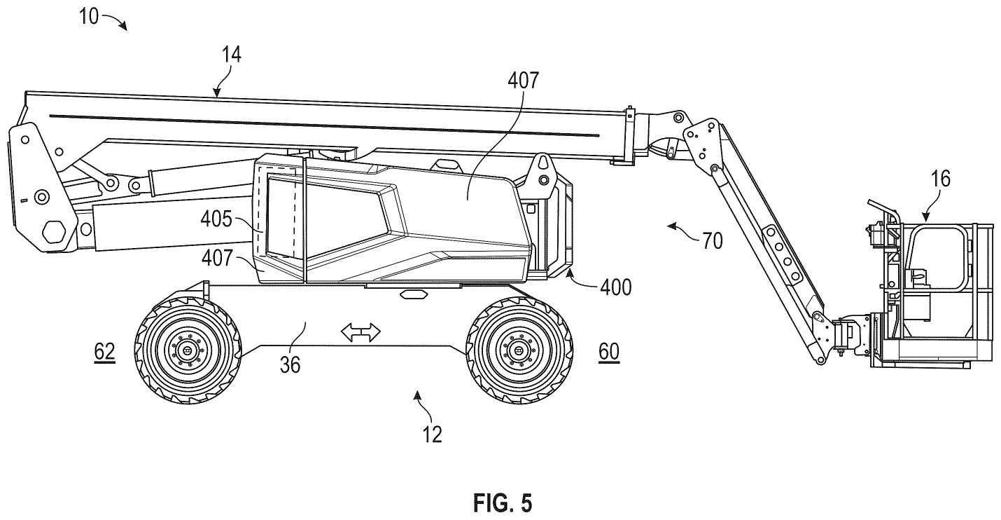

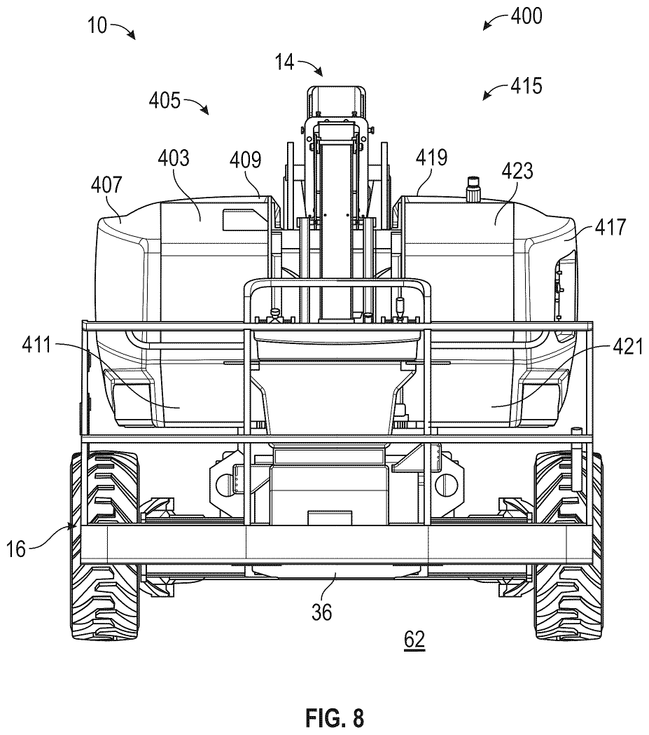

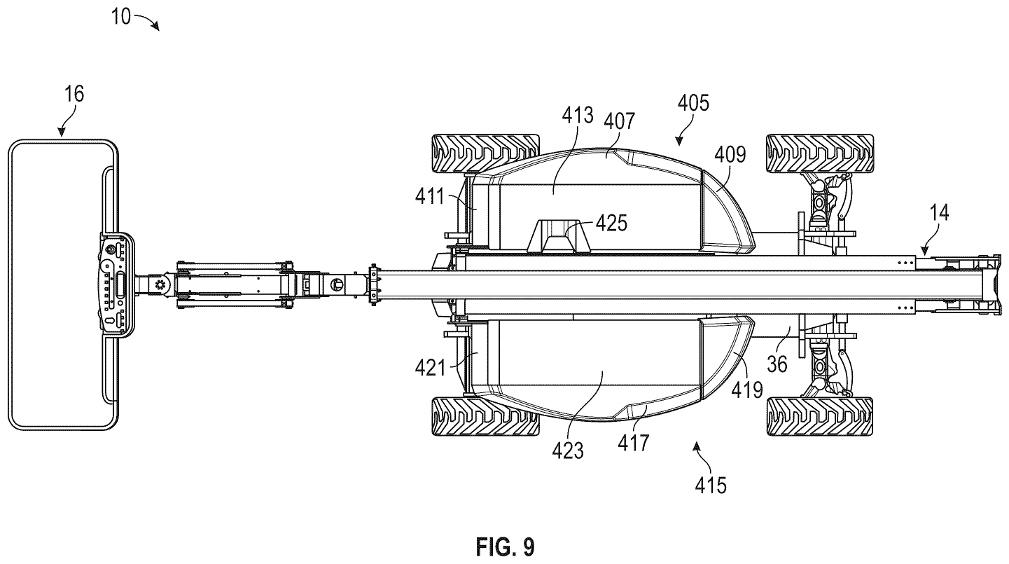

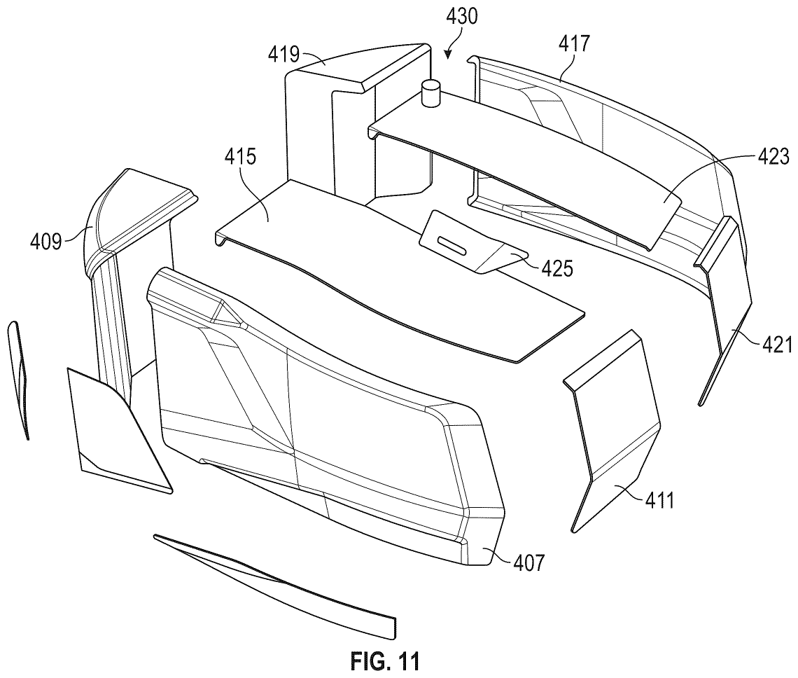

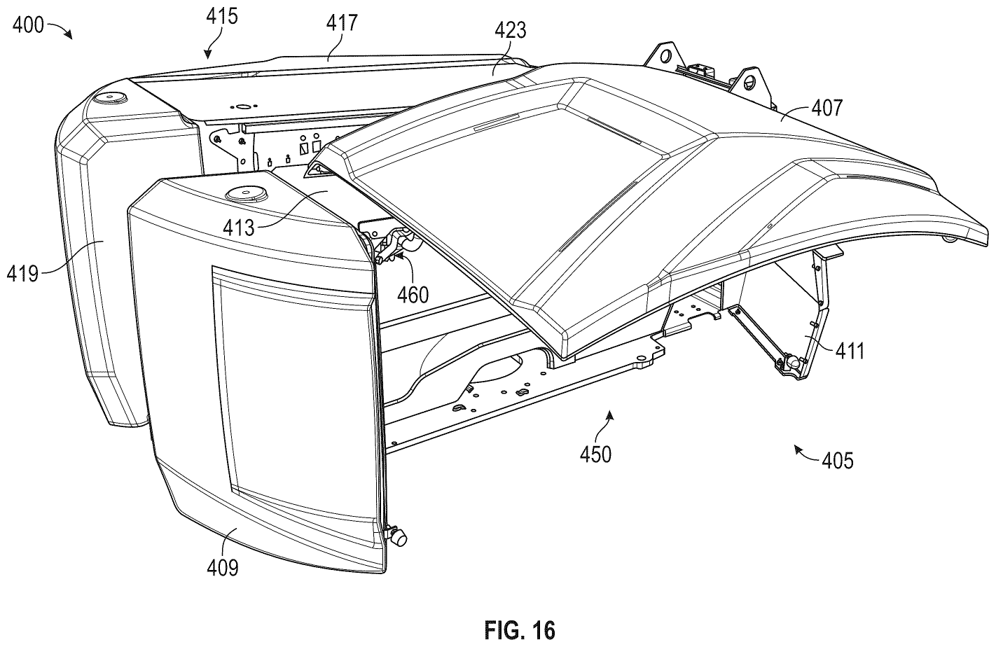

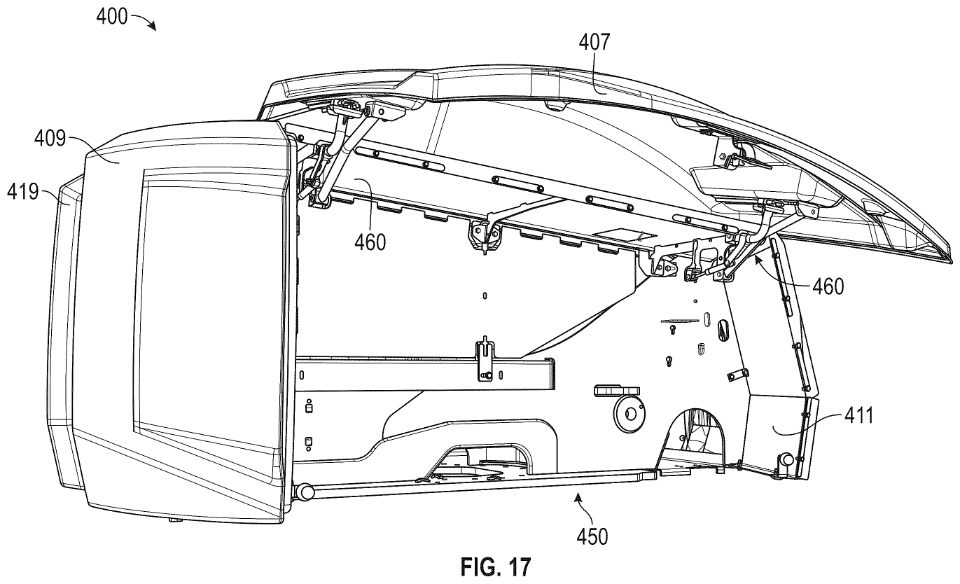

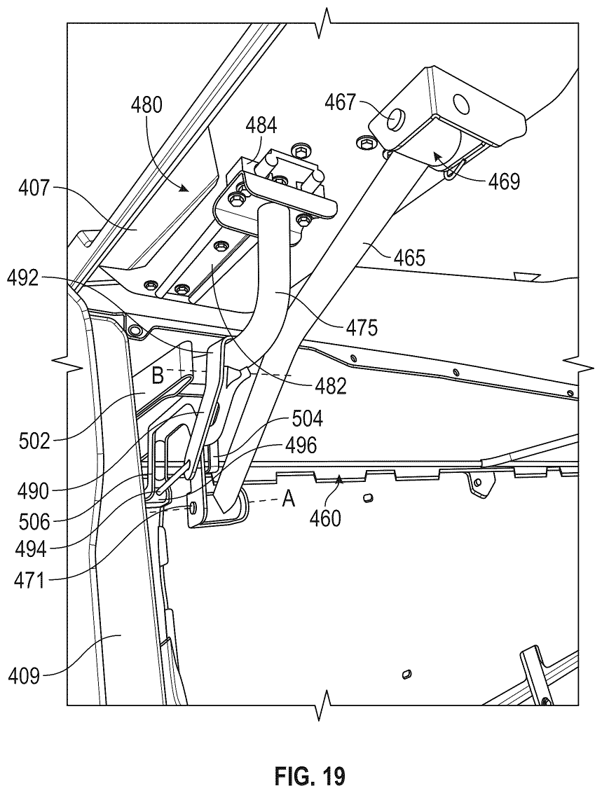

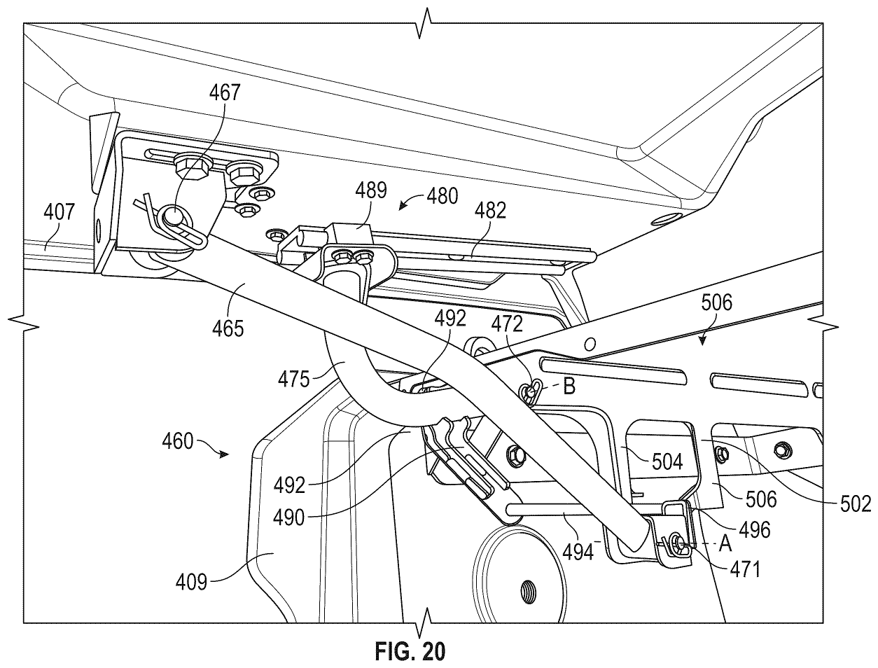

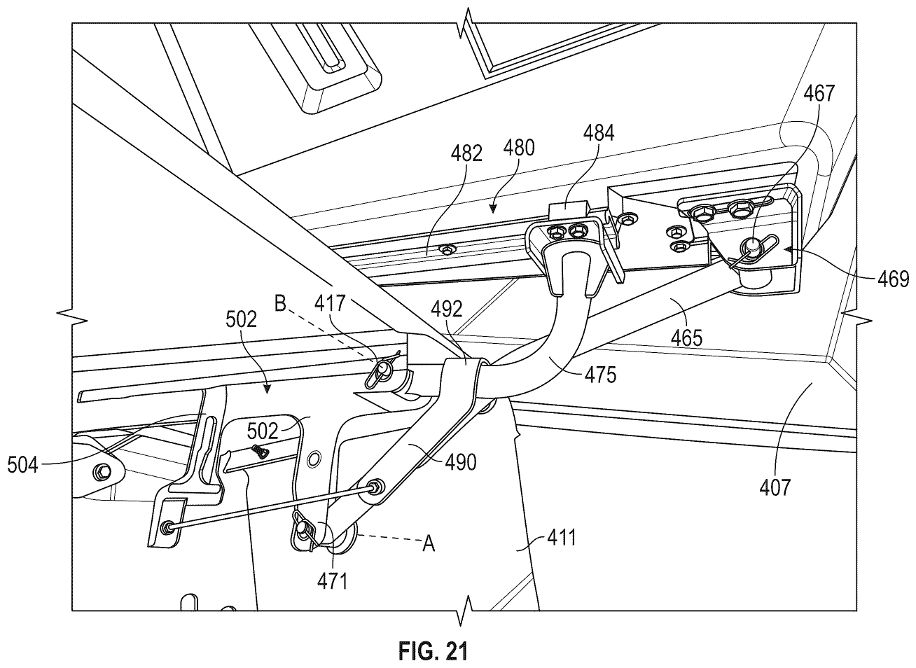

Referring to FIGS. 5-21, the lift device 10 may include modular hood (enclosure, external body, shell, etc.) shown as hood 400, enclosing or substantially enclosing an interior of the turntable 70. In some embodiments, the hood 400 is watertight, however in other embodiments the hood 400 may include one or more gaps, seams, or apertures such that the turntable 70 is merely substantially enclosed by the hood 400. For example, while dust or water may penetrate the hood 400, larger pieces of debris, hand tools, rocks, or other (e.g., greater than 1 inch) items are generally prevented from entering the turntable 70 by the hood 400. The hood 400 may be clipped, pinned, latched, screwed, bolted, or otherwise removably coupled to the turntable 70. The hood 400 is coupled to the turntable 70 such that movement of the turntable 70 also moves the hood 400, and the hood 400 is shaped to ensure the turntable 70 maintains the same freedom of movement with the hood 400 as without.

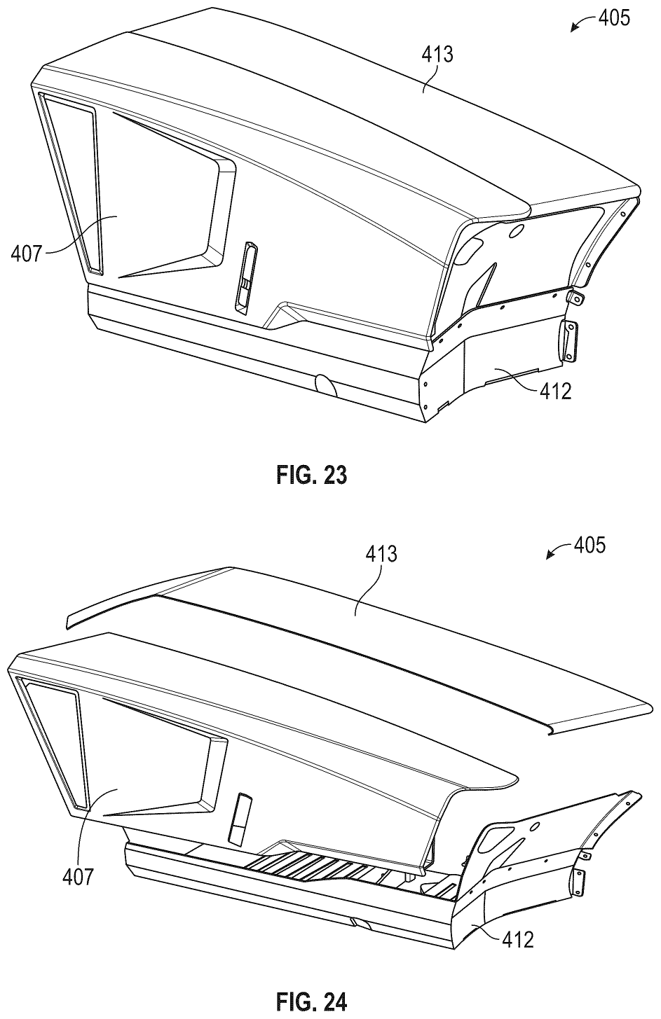

Referring particularly to FIGS. 5-9, the hood 400 is intersected by the lift assembly 14 into two halves (portions, segments, assemblies, etc.) shown as first half 405 and second half 415. Each of the first half 405 and the second half 415 may be composed of multiple panels (e.g., segments, pieces, parts, etc.) that each individually and removably coupled to the turntable 70 to form the first half 405 and the second half 415. In some embodiments, there may be gaps or seems between the panels. Still in other embodiments, gaskets or seals may fill the seams. The panels of the hood 400 can be individually removed to provide access to the interior of the turntable 70. In some embodiments, only one of the first half 405 or the second half 415 may be used. For example, see FIGS. 22-24 which show a lift device 10 as a telehandler and using a first half 405 of hood 400 as a modular hood.

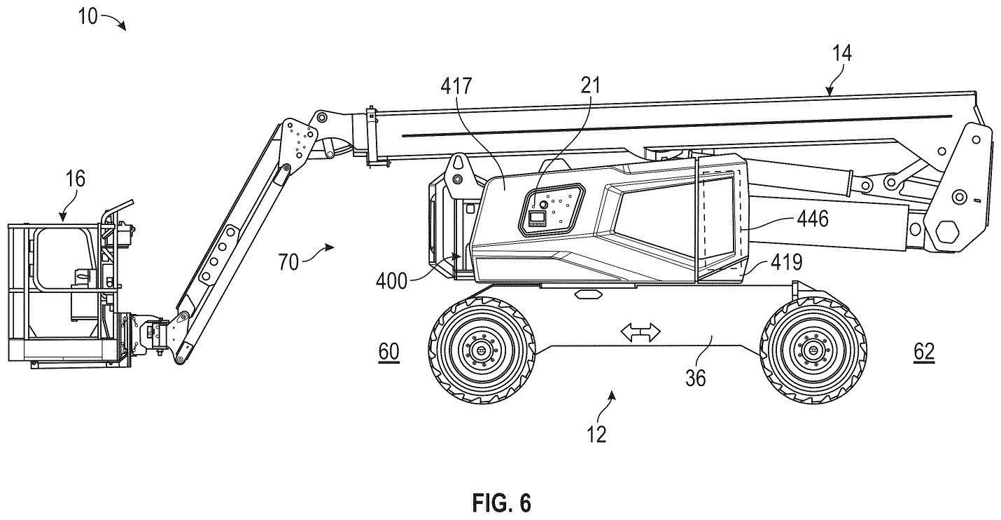

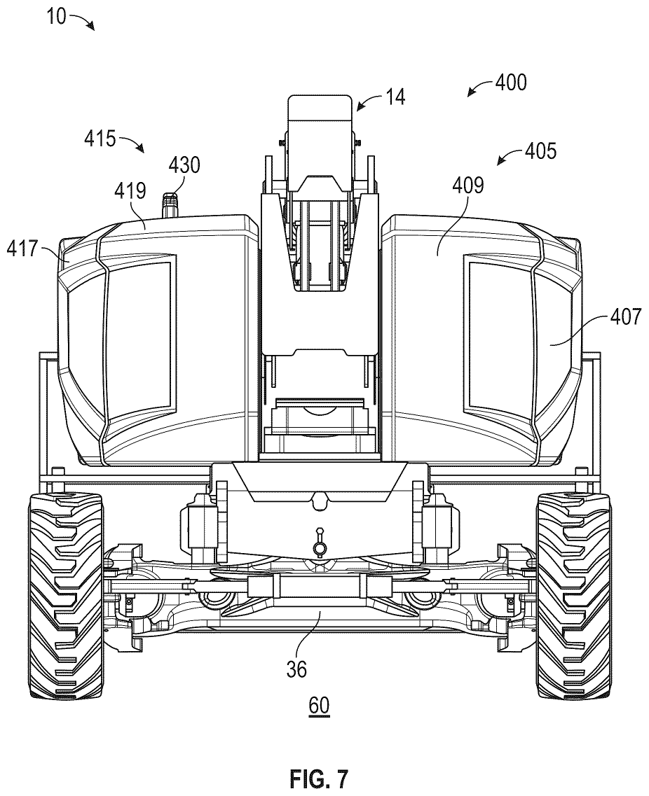

Referring particularly to FIG. 6, the hood 400 may include controls or other inputs electrically or communicably coupled to the turntable 70, such as user interface 21. In such embodiments, the hood 400 is coupled to the turntable 70 such that a user interface 21 can interact with and otherwise control the lift device 10. Referring particularly to FIG. 7, the hood 400 may also include one or more lights, alarms, or beacons to track the lift device 10 and communicate with an operator, shown as beacon 430. The beacon 430 may be, for example, a ClearSky™ beacon from JLG™.

The hood 400 may include one or more counterweights or counterbalances, shown as counterweight 435 in the first half 405 and counterweight 440 in the second half 415. The counterweights 435, 440 may be integrated into one or more panels of the hood 400 to balance the mass of the lift assembly 14 and the platform assembly 16. In some embodiments, a portion of the hood 400 is hollow and is filled with a mass to form the counterweights 435, 440. In some embodiments a portion of the hood 400 is

Referring now to FIGS. 5-11, the hood 400 comprises one or more body panels shown as a plurality of modular panels 407-414 and 417-424. The modular panels 407-414 and 417-424 may be removably coupled to the turntable 70 and/or other of the modular panels 407-414 and 417-424. In some embodiments, all modular panels 407-414 and 417-424 make up the hood 400, whereas in other embodiments one or more of the modular panels 407-414 and 417-424 are excluded. The first half 405 and the second half 415 include a door, hatch, or otherwise movable panel shown as first access panel 407 and second access panel 417, respectively. The first access panel 407 is coupled to first side of turntable 70 and the second access panel 417 is coupled to a second side of turntable 70. The first access panel 407 and the second access panel 417 extend generally vertically and are substantially parallel with the lift assembly 14. The first access panel 407 and the second access panel 417 extend at least partially between the rear 60 and the front 62 of the lift device 10. The first access panel 407 and the second access panel 417 may extend entirely or only partially between the rear 60 and the front 62. At least one of the first access panel 407 or the second access panel 417 are moveable relative to the rest of the hood 400 to provide access to an interior of the turntable 70 to a user. In some embodiments, for example, only the first access panel 407 is movably coupled to the turntable 70. In other embodiments, both the first access panel 407 and the second access panel 417 are moveable coupled to the turntable 70. The first access panel 407 and the second access panel may be planar or non-planar. In some embodiments, first access panel 407 and the second access panel 417 includes indentions, protrusions, or other shapes to accommodate and form around internal components of the turntable 70.

Referring still to FIGS. 5-11, the first half 405 and the second half 415 each include a front panel, shown as first front panel 409 and second front panel 419. The first front panel 409 and second front panel 419 are positioned proximate the front 62 of the lift device 10. The first front panel 409 and second front panel 419 may include a counterweight or counterbalance such as counterweights 435, 440, respectively. The entire first front panel 409 and second front panel 419 may be considered the counterweights 435, 440 or the counterweights 435, 440 may only be positioned in one or more parts of the first front panel 409 and second front panel 419. In some embodiments, the first front panel 409 and second front panel 419 are cast components made of cast iron, steel, or other materials. In other embodiments, the first front panel 409 and second front panel 419 are made of one or more components such as a shell and a filler material, such that the weight of the first front panel 409 and second front panel 419 can be adjusted by adjusting the quantity of the filler material. The filler material may also be cast iron, steel, etc. or other materials to impart weight to the first front panel 409 and second front panel 419. The first front panel 409 and second front panel 419 extend across a front of the first half 405 and the second half 415 respectively and may also extend at least partially between the front 62 and the rear 60 of the lift device. In some embodiments, only one of the front panel 409 or the second front panel 419 include a counterweight. For example, one of counterweights 435, 440 may be excluded.

Referring still to FIGS. 5-11, the first half 405 and the second half 415 each include a top panel, shown as first top panel 413 and second top panel 423. The first top panel 413 abuts the first access panel 407 and the first front panel 409, and the second top panel 423 abuts the second access panel 417 and the second front panel 419. The first top panel 413 and the second top panel 423 extend horizontally between the first access panel 407 or the second access panel 417 and the lift assembly 14, respectively, to act as a roof, ceiling, cover, or top to the turntable 70. The first top panel 413 and the second top panel 423 are substantially orthogonal to the plane of the first access panel 407 and the second access panel 417.

In some embodiments, at least one of the first top panel 413 or the second top panel 423 includes a venturi, shown as venturi 425. The venturi 425 fluidly couples the interior of the hood 400 and turntable 70 with an external environment of the lift device. The hood 400 may enclose one or more fans coupled to the lift device which draw air through the venturi 425 into the interior of the hood 400. The inlet of the venturi 425 may be covered with a mesh or permeable membrane which lets air pass through into the hood 400 but blocks larger particles such as welding slag from entering the interior of the hood 400.

Referring still to FIGS. 5-11, the first half 405 and the second half 415 each include a rear panel, shown as a first rear panel 411 and a second rear panel 421 respectively. The first rear panel 411 and a second rear panel 421 are positioned proximate a rear 60 of the lift device 10 on either side of the lift apparatus 40. The first rear panel 411 abuts or is adjacent to a rear edge of the first access panel 407 and a rear edge of the first top panel 413. The second rear panel 421 abuts or is adjacent to a rear edge of the second access panel 417 and a rear edge of the second top panel 423. The first rear panel 411 and a second rear panel 421 includes at least one bend or fold such that the first rear panel 411 and a second rear panel 421 each include at least two planar surfaces. The first rear panel 411 and a second rear panel 421 may also include additional planar surfaces. While shown as including one or more planer surfaces, the first rear panel 411 and the second rear panel 421 are generally orthogonal to the first access panel 407, the first top panel 413, the second access panel 417, and the second top panel 423, respectively.

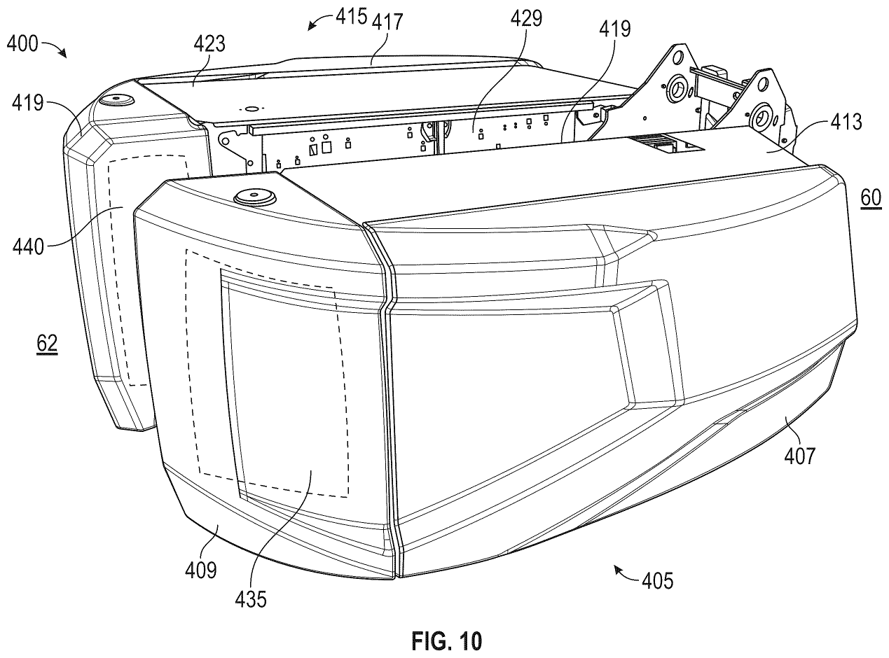

Referring particularly to FIG. 10, the first half 405 includes a first interior panel 414 and the second half 415 includes a second interior panel 424. The first interior panel 414 abuts or is adjacent to the first front panel 409, the first rear panel 411, and the first top panel 413. The second interior panel 424 abuts or is adjacent to the second front panel 419, the second rear panel 421, and the second top panel 423. The first interior panel 414 and the second interior panel 424 may be planar or non-planar, and they generally extend in a vertical plane parallel to the vertical planes of the first access panel 407 and the second access panel 417, respectively. In some embodiments, the first interior panel 414 and the second interior panel 424 are attached to or a part of the lift assembly 14.

The panels 407-414 and 417-424 may be composed of one or more materials. For example, the panels 407-414 and 417-424 made me made of DCPD, fiberglass, thermoformed HDPE, thermoformed TPO, steel, aluminum, or other metals or plastics. One or more panels 407-414 and 417-424 themselves may be made of a different material than another of the panels 407-414 and 417-424. For example, a first access panel 407 may be made a relatively light thermoplastic, making the first access panel 407 light and easier for a user to lift, but the first top panel 413 may be made of steel, as the first top panel 413 is more likely to experience impacts from falling items during operation of the lift device 10. All the panels 407-414 and 417-424 may be composed of the same material, which is selected based on one or more features of the lift device 10 such as its size, country of use, etc.

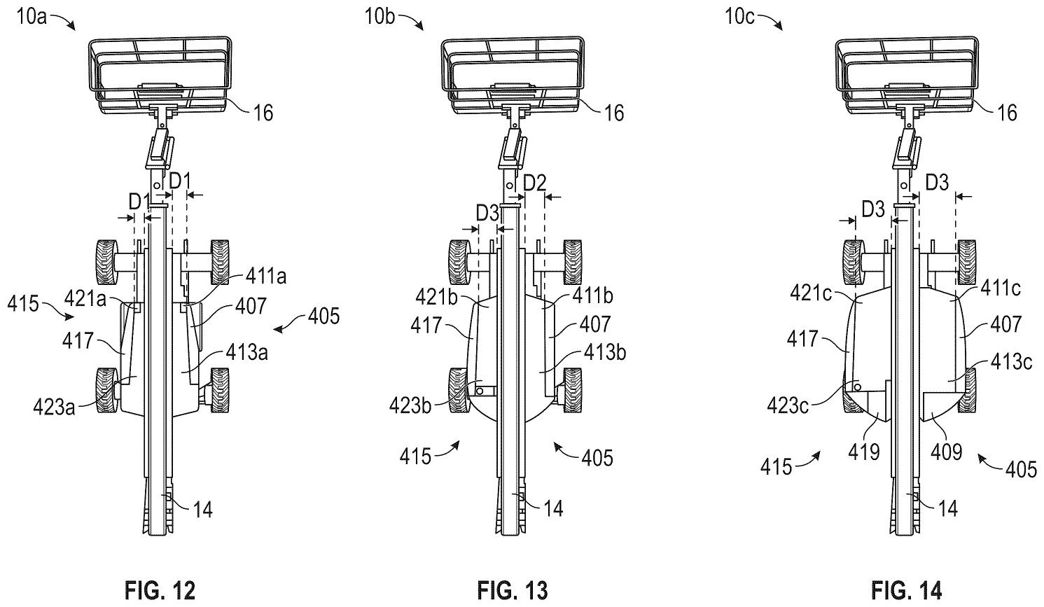

Referring particularly to FIGS. 12-14, various lift devices 10a-10c of different sizes are shown. The hood 400 is a modular system, such that each of the lift devices 10a-10c, while of various sizes, includes one or more of the same panels 407-414 and 417-424. The first access panel 407, the first front panel 409, the second access panel 417, and the second front panel 419 may be common panels. Common panels may be used on more than one model or size of lift devices 10a-10c, and the dimensions of the common panels do not change. Beneficially, this means a single design of a common panel, such as first access panel 407, can be produced and installed on each of the lift devices 10a-10c. This allows for more efficient manufacturing, transportation, and maintenance for the respective lift device 10.

Referring still to FIGS. 12-14, the first rear panel 411, the first top panel 413, the second rear panel 421, and the second top panel 423 are scalable panels. Scalable panels are manufactured with variations in one or more dimensions of the scalable panel such that, when combined with the common panels (e.g., the first access panel 407, the first front panel 409, the second access panel 417, and the second front panel 419) the hood 400 can fit differently sized lift devices 10. In some embodiments, there is a plurality of each scalable panel (e.g., the first rear panel 411, the first top panel 413, the second rear panel 421, and the second top panel 423), wherein each of the plurality of scalable panels are of a different size. For example, with reference to lift devices 10a-10c, there can be a plurality of three different first top panels 413, each of the plurality of first top panels 413 having a different width. In some embodiments, only one dimension of the plurality of first top panels 413 is altered. For example. The length of each of the plurality of first top panels 413 may be the same, such that each of the plurality of first top panels 23 can still engage with or otherwise fit into the hood 400. In some embodiments, the lift device 10 has a turntable 70 of with a turntable width, and a first top panel 413 is selected from the plurality of first top panels 413 based on the turntable width to ensure the hood 400 can fit the turntable 70. In some embodiments, only the dimensions of the scalable panels need to be altered to adjust the hood 400 to fit a different lift device 10. When manufacturing a lift device 10, a plurality of scalable panels may be manufactured and then a single scalable panel may be selected from the plurality to fit the lift device 10.

Referring still to FIGS. 12-14, while one or more dimensions of the scalable panels may change, the scalable panels include one or more generic engagement sections that abut or are adjacent to the common panels, such that even though a width of the scalable panel may be changed, the scalable panel still engages with the common panels in the same fashion.

Referring particularly to FIG. 12, a lift device is shown as lift device 10a to include the hood 400. The hood 400 includes a first half 405 and a second half 415 separated by a lift assembly 14. The first half 405 and the second half 415 include a first access panel 407, a second access panel 417, a first rear panel 411a, a second rear panel 421a, a first top panel 413a, and a second top panel 423a, respectively. The first rear panel 411a, the second rear panel 421a, the first top panel 413a, and the second top panel 423a have a width shown was distance D1.

Referring particularly to FIG. 13, a lift device is shown as lift device 10b to include the hood 400. The hood 400 includes a first half 405 and a second half 415 separated by a lift assembly 14. The first half 405 and the second half 415 include a first access panel 407, a second access panel 417, a first rear panel 411b, a second rear panel 421b, a first top panel 413b, and a second top panel 423b, respectively. The first rear panel 411b, the second rear panel 421b, the first top panel 413b, and the second top panel 423b have a width shown was distance D2. Distance D2 is greater than the distance D1 of the first rear panel 411a, the second rear panel 421a, the first top panel 413a, and the second top panel 423a of lift device 10a. The first access panel 407 and the second access panel 417 are the same for both lift device 10a and lift device 10b.

Referring particularly to FIG. 14, a lift device is shown as lift device 10c to include the hood 400. The hood 400 includes a first half 405 and a second half 415 separated by a lift assembly 14. The first half 405 and the second half 415 include a first access panel 407, a second access panel 417, a first front panel 409, second front panel 419, a first rear panel 411c, a second rear panel 421c, a first top panel 413c, and a second top panel 423c, respectively. The first rear panel 411c, the second rear panel 421c, the first top panel 413c, and the second top panel 423c have a width shown was distance D3. Distance D3 is greater than the distance D1 and distance D2 of lift device 10a and lift device 10b. The first access panel 407 and the second access panel 417 are the same for both lift device 10a and lift device 10b. The first front panel 409 and the second front panel 419 are also added to hood 400 for lift device 10c as the width D3 of the turntable 70 is sufficient to fit the common first front panel 409 and the second front panel 419.

Beneficially, the modular panels 407-414 and 417-424 allow for a combination of common panels and scalable panels to make up the hood 400, such that the common panels of the hood 400 can be used across a variety of lift devices of different sizes.

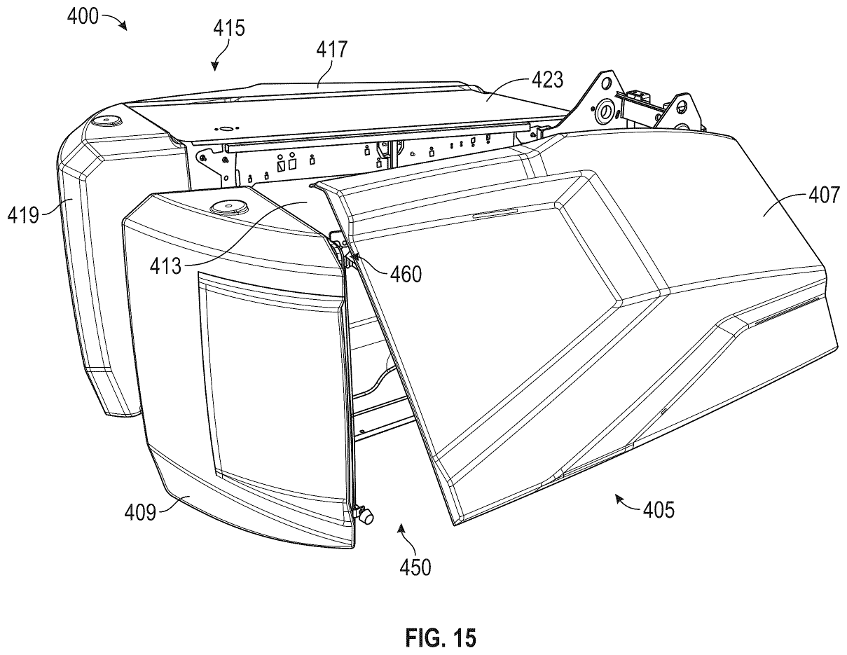

Referring to FIGS. 15-17, the first access panel 407 is rotatably coupled to the turntable 70 via one or more hinges, shown as hinge 460. In some embodiments, only a single hinge 460 is used. The first access panel 407 rotates around a first longitudinal axis, shown as axis A. When opened, the first access panel 407 provides access to an interior of the hood 400, shown as interior 450. When installed on a turntable 70, the interior 450 may be include several internal components of the turntable 70.

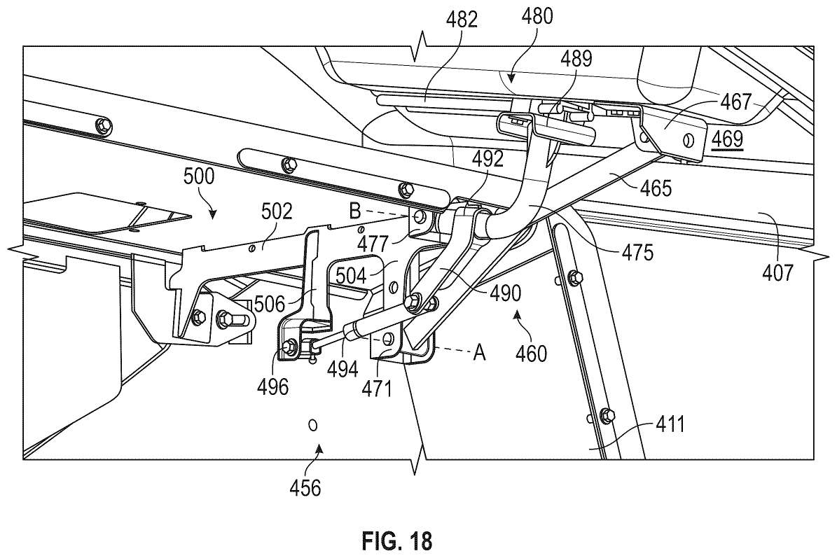

Referring to FIGS. 18-20, the hinge 460 is shown in greater detail. The hinge 460 couples the first access panel 407 to an internal frame of the turntable 70, shown as frame 500. The frame 500 includes a first lateral rail shown as rail 502 extending laterally within the interior 450. Coupled to the first lateral rail 502 is a post, shown as first post 504. In some embodiments, first post 504 and the first lateral rail 502 are a single, unitary, component. In other embodiments, the first post 504 and the first lateral rail 502 are multiple components coupled together. The first post 504 extends away from and orthogonal too the first lateral rail 502 towards the base 36 of the lift device 10. Coupled to the first lateral rail 502 is a post, shown as a second post 506. In some embodiments, second post 506 and the first lateral rail 502 are a single, unitary, component. In other embodiments, the second post 506 and the first lateral rail 502 are multiple components coupled together. The second post 506 extends away from and orthogonal too the first lateral rail 502 towards the base 36 of the lift device 10. The second post 506 is positioned laterally inward towards the lift assembly 14 relative to the first post 504.

Still referring to FIGS. 18-20, the hinge 460 includes a first rotatably linkage, shown as a first linkage 465. A first end of the first linkage is pivotably coupled to the first access panel 407 at pivot joint 467 at a position 469 on the first access panel 407. A second end of the first linkage 465 is coupled to the frame 500 of the turntable 70 at the pivot joint 471 at an end of the first post 504. The pivot joints 467 and 471 are shown as swivel pin pivot joints, however other types of pivot or rotary joints may be used. The first linkage 465 may be straight or may include one or more kinks, bends, or other non-linear features, which can be made to accommodate components within the interior 450. The first access panel 407 and the first linkage 465 rotate around the axis A at pivot joint 471. Axis A is a longitudinal axis substantially parallel with a longitudinal axis of the lift assembly 14 in a assembled lift device 10. Axis A is offset from a top of the hood 400 based on a length of the first post 504.

Still referring to FIGS. 18-20, the hinge 460 includes a second rotatable linkage, shown as second linkage 475. The second linkage 475 is pivotably coupled to the frame 500 of the turntable 70 at pivot joint 477 at an end of the first lateral rail 502, such that the second linkage 475 rotates around an axis B. Axis B is a longitudinal axis substantially parallel with a longitudinal axis of the lift assembly 14 in a assembled lift device 10 and axis A. The second linkage 475 is slidably coupled to the first access panel 407 a sliding (e.g., translating, moving, etc.) joint, shown as sliding joint 480. Sliding joint 480 includes a track 482 coupled to the first access panel 407 and a carrier 484 coupled to an end of the second linkage 475. The second linkage 475 is arcuate, such that at the point joint, the second linkage extends in a direction substantially (e.g., +/−10%) orthogonal to the direction the pivot extends in at the sliding joint 480.

As the first linkage 465 and the first access panel 407 rotate around the axis A, the second linkage 475 rotates around the axis B and slides along the track 482. In a fully open position of the first access panel 407, the carrier 484 is at a first end of the track 482. As the first access panel 407 is closed, the second linkage 475 and the carrier 484 slide along the track 482 until in a closed position, the second linkage 475 and the carrier 484 are at or proximate to a second end of the track 482.

The hinge 460 includes a third moveable linkage, shown as third linkage 490. The third linkage 490 is slidably coupled to the second linkage 475 via collar 492. The collar 492 surrounds or substantially surrounds the second linkage 475, letting the third linkage 490 translate along the length of the second linkage 475. While shown coupled to the second linkage 475 via the collar 492, the third linkage 490 can alternatively be coupled to the second linkage 475 by any other slidable connection such that the point of contact between the third linkage 490 and the second linkage 475 can move the length of the second linkage 475, for example a c-shaped clasp that partially surrounds the second linkage 475.

Opposite the collar 492 the third linkage 490 is pivotably coupled to an actuator, shown as actuator 494. The actuator 494 may be any type of actuator, including an electric actuator, a pneumatic cylinder, a hydraulic actuator, etc. The actuator 494 is pivotably coupled to the end of the post 506 of the frame 500 at the pivot joint 496, thereby coupling the third linkage 490 to the frame 500. The actuator 494 imparts a force on the third linkage 490. Via the collar 492, the force from the actuator 494 is transferred to the second linkage 475. As the first access panel 407 is opened to the open position in FIGS. 18-20, the force from the actuator 494 is imparted to the second linkage 475, which dues to its arcuate shape and the sliding joint 480, transforms the direction of the force and applies it to the first access panel 407 in a direction substantially perpendicular to the plane of the first access panel 407 throughout the rotation of the first access panel 407, helping a user in opening the first access panel 407. Also, in the open position, the force of the actuator 494 is transformed by the second linkage 475 into a substantially vertical force to hold the first access panel 407 in the open position.

While hinge 460 is shown with reference to first access panel 407, in some embodiments one or more of the other modular panels 407-414 and 417-424 may be similarly rotatably coupled to the turntable 70. For example, the second access panel 417 may similarly include one or more hinges 460 such that the second access panel 417 is also rotatable relative to the rest of the hood 400.

Referring now to FIGS. 22-24, a lift device 10 is shown as a telehandler, according to some embodiments. The lift device 10 includes at least one half (e.g., first half 405) of a modular hood, such as modular hood 400. In the embodiment shown in FIGS. 22-24, the first half 405 of the modular hood 400 includes one or more scalable panels (e.g., first top panel 413) and one or more common panels (e.g., first access panel 407). The lift device 10 also includes additional scalable panels such as first bottom panel 412. In some embodiments, first bottom panel 412 is similar to first rear panel 411 but also includes a bottom portion extending along the length of the lift device 10 and the first access panel 407, providing two sides of the first half 405 of the modular hood 400.

It should be understood that while the above embodiments of lift device 10 disclose common panels and scalable panels of various shapes and sizes, the shapes and sizes of the common panels and scalable panels can vary, in different embodiments, without departing from the scope of the invention. For example, the shape of the first access panel 407, while existing as a common panel in relation to a set of scalable panels with altering dimensions, may be different in one embodiment than another.

### Configuration of the Exemplary Embodiments

As utilized herein with respect to numerical ranges, the terms “approximately,” “about,” “substantially,” and similar terms generally mean+/−10% of the disclosed values. If values are not disclosed, they mean+/−10% of the zero or absolute value. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure.

It is important to note that the construction and arrangement of the lift device 10 and control system 100 as shown in the various exemplary embodiments is illustrative only. Additionally, any element disclosed in one embodiment may be incorporated or utilized with any other embodiment disclosed herein. For example, the techniques of the platform sensors 202 of the exemplary embodiment shown in at least FIG. 13 may be incorporated in the lift device 10 of the embodiment shown in at least FIG. 5. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A work machine comprising;
a chassis;
a turntable coupled to the chassis, the turntable comprising an internal frame and an external body; and
a lift assembly coupled to the turntable, the lift assembly configured to raise or lower a platform coupled to the lift assembly,
wherein the external body comprises a plurality of body panels removably coupled to the internal frame to substantially enclose the internal frame and form an internal cavity, and
wherein at least one of the plurality of body panels is a front panel comprising a counterweight.

2. The work machine of claim 1, wherein in a retracted position of the lift assembly the platform is positioned proximate a rear of the work machine, and wherein the front panel is positioned at a front of the work machine opposite the rear.

3. The work machine of claim 1, wherein the counterweight is a cast counterweight.

4. The work machine of claim 1, further comprising a plurality of front panels of different weights, wherein the front panel is selected from the plurality of front panels based on a weight of the lift assembly.

5. The work machine of claim 1, wherein the front panel is a first front panel comprising a first counterweight, the external body further comprising a second front panel comprising a second counterweight, the first front panel and the second front panel positioned on opposite sides of the lift assembly.

6. The work machine of claim 5, wherein a first front panel weight and a second front panel weights are different.

7. A work machine comprising;
a chassis;
a turntable coupled to the chassis, the turntable comprising an internal frame and an external body; and
a lift assembly coupled to the turntable, the lift assembly configured to raise or lower a platform coupled to the lift assembly,
wherein the external body comprises a hood panel rotatably coupled to the internal frame via a hinge, the hinge comprising:
a first linkage with a first length pivotably coupled to the hood panel and pivotably coupled to the internal frame such that the first linkage and the hood panel rotates around a first longitudinal axis;
an arcuate second linkage with a second length slidably coupled to the hood panel and pivotably coupled to the internal frame such that the second linkage rotates around a second longitudinal axis, the second length shorter than the first length;
a third linkage slidably coupled to the second linkage to traverse the second length; and
an actuator pivotably coupled to the third linkage and pivotably coupled to the internal frame.

8. The work machine of claim 7, wherein the first longitudinal axis is laterally offset from the second longitudinal axis.

9. The work machine of claim 7, wherein the first longitudinal axis is longitudinally offset from the second longitudinal axis.

10. The work machine of claim 7, wherein the first longitudinal axis is parallel to the second longitudinal axis.

11. The work machine of claim 7, wherein the actuator is an electric actuator, a pneumatic cylinder, or a hydraulic actuator.

12. The work machine of claim 7, wherein the third linkage is slidably coupled to the second linkage via a collar at a first end of the third linkage encircling the second linkage.

13. The work machine of claim 7, wherein the second linkage is slidably coupled to the hood panel via a track coupled to the hood panel and a runner slidably coupled to the second linkage and slidably coupled to the track.

14. The work machine of claim 7, wherein the first linkage is pivotably coupled to the hood panel a distance D from a top of the hood panel such that in an open position the top of the hood panel extends laterally inward past the first longitudinal axis.

15. The work machine of claim 7, wherein the first linkage is pivotably coupled to the hood panel at a first position, and wherein the second linkage is slidably coupled to the hood panel between a top edge of the hood panel and the first position.

16. The work machine of claim 7, wherein the hinge is a first hinge, and wherein the hood panel is rotatably coupled to the internal frame via the first hinge and a second hinge, the second hinge comprising:
a fourth linkage with a fourth length pivotably coupled to the hood panel and pivotably coupled to the internal frame such that the fourth linkage and the hood panel rotates around a fourth longitudinal axis;
an arcuate fifth linkage with a fifth length slidably coupled to the hood panel and pivotably coupled to the internal frame such that the fifth linkage rotates around a fifth longitudinal axis, the fifth length shorter than the fourth length;
a sixth linkage slidably coupled to the fifth linkage to traverse the fifth length; and
a second actuator pivotably coupled to the sixth linkage and pivotably coupled to the internal frame.

17. The work machine of claim 7, wherein the internal frame comprises a longitudinal rail and a lateral rail coupled to the longitudinal rail, wherein the first linkage is rotatably coupled to a first post coupled to the lateral rail and extending orthogonal to the longitudinal rail and the lateral rail, the second linkage is rotatably coupled to an end of the lateral rail, and the actuator is rotatably coupled to a second post coupled to the lateral rail and extending away from the lateral rail orthogonal to the longitudinal rail and the lateral rail, the second post laterally inward relative to the first post.

18. A method of assembling a work machine comprising:
providing a chassis;
rotatably coupling a turntable to the chassis;
pivotably coupling a lift assembly to the turntable, the lift assembly configured to raise or lower a platform coupled to the lift assembly;
coupling a hood panel to an internal frame of the turntable,
coupling a rear panel to the internal frame; and
coupling a top panel to the internal frame, wherein the top panel is selected from a plurality of top panels of different widths based on one or more dimensions of the chassis, the turntable, or the lift assembly.

19. The method of claim 18, further comprising selecting from steel or thermoplastics for the hood panel, the rear panel, or the top panel, based on a country of use for the work machine.

20. The method of claim 18, wherein at least one of the hood panel, the rear panel or the top panel includes a cast counterweight.
